(19) United States
(12) Patent Application Publication
(10) Pub. No.: US 2023/0008525 A1
(43) Pub. Date: Jan. 12, 2023

(54) SELF-TRACE FOR CLIENT-SERVER CONNECTIONS

(71) Applicant: Fastly, Inc., San Francisco, CA (US)

(72) Inventors: Janardhan Iyengar, Truckee, CA (US); Kazuho Oku, Tokyo (JP)

(21) Appl. No.: 17/859,258

(22) Filed: Jul. 7, 2022

Related U.S. Application Data
(60) Provisional application No. 63/219,198, filed on Jul. 7, 2021.

(51) Int. Cl. H04L 67/146

(52) U.S. Cl. CPC H04L 67/146

(57) ABSTRACT

Technology is disclosed herein for obtaining state information on client-server connections. In an implementation, a client computer sends a self-trace request to a server computer to obtain state information about a connection between the client computer and the server computer. The server computer receives the request, determines to reply with the state information, and streams the state information to the client computing device.

### RELATED APPLICATIONS

This application is related to and claims priority to U.S. Provisional Patent Application 63/219,198 entitled “SELF-TRACE FOR CLIENT-SERVER CONNECTIONS” filed on Jul. 7, 2021, which is hereby incorporated by reference in its entirety.

### TECHNICAL FIELD

Aspects of the disclosure are related to the field of Internet communications and, more particularly, to protocols for connecting clients and servers.

### BACKGROUND

An endpoint's view of a hyper-text transfer protocol (HTTP) connection is limited to its own state; neither endpoint is privy to the peer's view of the connection. This limitation has some familiar and common consequences, at both clients and servers.

A client that experiences functional or performance issues with a server has no visibility into the server's connection state. A user who wishes to report such performance issues cannot provide more information than the time of the connection and perhaps the Internet protocol (IP) address of the client. Server operators often do not proactively retain detailed logs of all client connections, and as a result, they may not have adequate information to meaningfully investigate a client's report.

Proactively maintaining detailed logs has challenges for a server operator: storage or processor considerations can cause servers to retain only sampled logs or limit the extent of logging. If retained, server logs are often sanitized of client-specific personally identifiable information, making it difficult to identify specific connections reported as problematic by users.

### OVERVIEW

Technology is disclosed herein for obtaining state information on client-server connections. In an implementation, a client computer sends a self-trace request to a server computer to obtain state information about a connection between the client computer and the server computer. The server computer receives the request, determines to reply with the state information, and streams the state information to the client computing device.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification's, and equivalents.

FIG. 1 illustrates an operational environment and a related operational scenario in an implementation of self-tracing for client-server connections.

FIG. 2 illustrates a computing system suitable for implementing the various operational environments, architectures, processes, scenarios, and sequences discussed below with respect to the Figures.

### DETAILED DESCRIPTION

Various implementations of a self-tracing mechanism for client-server connections are disclosed herein. In an implementation, a client requests a special uniform resource indicator (URI) from a server. The server interprets the URI as a request to trace the connection on which the request was received. The server responds by continuously streaming the server's view of the connection. The server's view is represented in state information that the server streams to the client on the connection.

The self-tracing technology disclosed herein provides a technical effect by eliminating the aforementioned issues of resource scaling and client privacy: a server chooses what information it shares with a client. In addition, a user on the client-side may make an active choice to share that information along with any issue reports to the server operator, if so desired.

It may be appreciated that the disclosed implementations allow for server-side logging if desired. In fact, server-side logging may remain desirable since not all errors will are reproducible and recordable on the client-side of the connection. For example, some classes of issues, such as connection establishment issues, are not possible to log using the self-trace implementations disclosed herein.

The disclosed self-tracing may be employed int he context of all HTTP versions including those that support request multiplexing. For example, in HTTP/2 and HTTP/3, a self-trace request results in a stream becoming dedicated for the streaming response from the server.

An example of the self-trace URI is ‘.well-known/self-trace’, a well-known URI to be used for self-tracing. For example, the self-tracing URI on ‘http://www.example.com/’ would be ‘http://www.example.com/.well-known/self-trace’.

When a server receives a GET request for the self-tracing URI, the server starts streaming the server's connection and streams a view for the connection on which that request was received. However, sending log lines in a self-trace can cause additional events that in turn generate more log lines to be sent, resulting in an infinite feedback loop of sending. For example, this can happen when a server's self-trace is a streaming event log, such as a streaming qlog trace [QLOG].

To prevent such infinite feedback loops, a server may suspend transmission of a self-trace response when this HTTP response is the only one in flight in the connection. The server may then resume transmission of the self-trace when a subsequent HTTP request is received on the same HTTP connection. In addition, multiple concurrent self-trace requests can similarly result in an infinite feedback loop. To mitigate, a server can handle at most one concurrent self-trace request on a connection.

Various implementations also mitigate security concerns presented by self-tracing as disclosed herein. For example, to prevent cross-origin attacks, Web browser access to self-tracing can be restricted to the same origin. In some cases, a forward proxy can coalesce HTTP requests from multiple clients. When such a proxy connects to an HTTP server that can self-trace, and if one of the proxied clients requests a self-trace, the server's trace to the client might contain connection and stream information on requests and responses issued by and for other proxied clients.

To prevent this information leak, servers can restrict use of self-tracing to only HTTPS connections, since the use of HTTPS through a forward proxy results in each client subject to the proxy establishing a separate connection to the server. Reverse proxies are sometimes configured to allow one HTTP connection to be used for serving multiple origins maintained by different entities. For example, this can happen when a multi-tenant content delivery network (CDN) server uses a single X.509 certificate for multiple customers. Under such circumstances, a malicious origin can use a script running on a web browser to fetch a self-trace that contains information about the other co-located origins and upload the collected trace back to the malicious origin. To address this attack, reverse proxies that forward HTTP requests to multiple origins belonging to different entities can do one or more of the following: 1) serve self-trace only from an origin maintained by the operator of the reverse proxy; 2) serve self-trace only when requests for one origin is in-flight on a given connection; and 3) disable self-tracing.

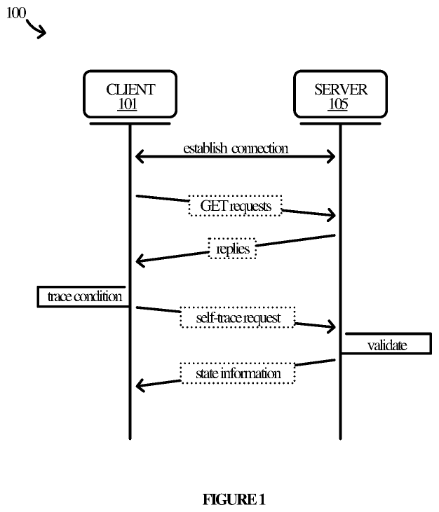

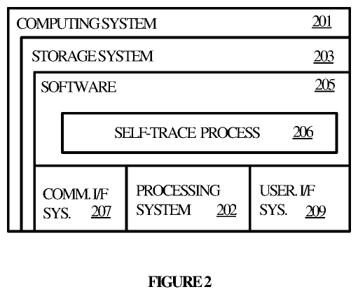

FIG. 1 illustrates an operational environment 100 in a brief scenario of self-tracing on client-server connections. Operational environment 100 includes a client 101 and a server 105. Client 101 is representative of any computing end-point that functions as a client with respect to a server. Client 101 may be implemented on any suitable computing device, an example of which is provided by computing device 200 in FIG. 2. Similarly, server 105 is representative of any computing node that functions as a server with respect to a client. Server 105 may be implemented on any suitable computing device, an example of which is also provided by computing device 200 in FIG. 2.

In operation, client 101 and server 105 establish a communication connection therebetween in accordance with a connection protocol (e.g., the Transport Connection Protocol, or TCP) in the context of an HTTP (or HTTPS) session. Client 101 sends requests to server 105 to obtain content such as web pages, audio and/or video data, electronic documents or files, or any other type of content. Server 105 replies to the requests with the requested content.

In some scenarios, server 105 may possess the content itself and can serve it immediately. In other scenarios, server 105 does not possess the content but rather obtains the content from another resource before serving it to client 101. For example, in a CDN scenario, server 105 may function as a cache node that retrieves content from an origin or other cache nodes if it does not possess the content locally.

Problems may be encountered that cause client 101 to request a self-trace from server 105. In an example, the connection between client 101 and server 105 may be performing slowly such that a delay is experienced on the client-side with respect to the content being served. In order to address any potential problems, client 101 sends a self-trace request to server 101 to obtain the server's view of the connection.

Server 105 receives the request and determines whether to stream the requested state information. This validation step mitigates against infinite feedback loops, attacks, and the other potential problems discussed above. Assuming the request is valid, server 105 streams state information to client 101 that gives client 101 a view of the connection from the perspective of server 105.

FIG. 2 illustrates computing system 201 that is representative of any system or collection of systems in which the various processes, programs, services, and scenarios disclosed herein may be implemented. Examples of computing system 201 include, but are not limited to, desktop and laptop computers, server computers, web servers, cloud computing platforms, and data center equipment, as well as any other type of physical or virtual server machine, container, and any variation or combination thereof.

Computing system 201 may be implemented as a single apparatus, system, or device or may be implemented in a distributed manner as multiple apparatuses, systems, or devices. Computing system 201 includes, but is not limited to, processing system 202, storage system 203, software 205, communication interface system 207, and user interface system 209 (optional). Processing system 202 is operatively coupled with storage system 203, communication interface system 207, and user interface system 209.

Processing system 202 loads and executes software 205 from storage system 203. Software 205 includes and implements self-trace process 206, which is representative of the self-trace processes discussed with respect to the preceding Figures. When executed by processing system 202 to provide direct server reply, software 205 directs processing system 202 to operate as described herein for at least the various processes, operational scenarios, and sequences discussed in the foregoing implementations. Computing system 201 may optionally include additional devices, features, or functionality not discussed for purposes of brevity.

Referring still to FIG. 2, processing system 202 may comprise a micro-processor and other circuitry that retrieves and executes software 205 from storage system 203. Processing system 202 may be implemented within a single processing device but may also be distributed across multiple processing devices or sub-systems that cooperate in executing program instructions. Examples of processing system 202 include general purpose central processing units, graphical processing units, application specific processors, and logic devices, as well as any other type of processing device, combinations, or variations thereof.

Storage system 203 may comprise any computer readable storage media readable by processing system 202 and capable of storing software 205. Storage system 203 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 203 may also include computer readable communication media over which at least some of software 205 may be communicated internally or externally. Storage system 203 may be implemented as a single storage device but may also be implemented across multiple storage devices or sub-systems co-located or distributed relative to each other. Storage system 203 may comprise additional elements, such as a controller, capable of communicating with processing system 202 or possibly other systems.

Software 205 (including self-trace process 206) may be implemented in program instructions and among other functions may, when executed by processing system 202, direct processing system 202 to operate as described with respect to the various operational scenarios, sequences, and processes illustrated herein. For example, software 205 may include program instructions for implementing a self-trace process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 205 may include additional processes, programs, or components, such as operating system software, virtualization software, or other application software. Software 205 may also comprise firmware or some other form of machine-readable processing instructions executable by processing system 202.

In general, software 205 may, when loaded into processing system 202 and executed, transform a suitable apparatus, system, or device (of which computing system 201 is representative) overall from a general-purpose computing system into a special-purpose computing system customized to perform self-tracing. Indeed, encoding software 205 on storage system 203 may transform the physical structure of storage system 203. The specific transformation of the physical structure may depend on various factors in different implementations of this description. Examples of such factors may include, but are not limited to, the technology used to implement the storage media of storage system 203 and whether the computer-storage media are characterized as primary or secondary storage, as well as other factors.

For example, if the computer readable storage media are implemented as semiconductor-based memory, software 205 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 207 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 201 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method comprising:
in a client computing device, sending a self-trace request to a server computer device to obtain state information about a connection between the client computing device and the server computer device; and
in the server computing device, receiving the self-trace request and streaming the state information to the client computing device.

2. A server computer comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive a self-trace request from a client computer over a connection established between the client computer and the server computer;
determine to reply to the self-trace request with state information associated with the connection between the client computer and the server computer; and
stream the state information over the connection to the client computer.

3. A client computer comprising:
one or more computer readable storage media;
one or more processors operatively coupled with the one or more computer readable storage media; and
program instructions stored on the one or more computer readable storage media that, when executed by the one or more processors, direct the computing apparatus to at least:
send a self-trace request to a server computer over a connection established between the client computer and the server computer, to obtain state information associated with the connection between the client computer and the server computer; and
receive the state information from the server computer.
